(19) United States
(12) Patent Application Publication
(10) Pub. No.: US 2026/0311929 A1
(43) Pub. Date: Oct. 8, 2026

(54) MAGNETIC SHUNT FOR TOROIDAL MAGNETIC ASSEMBLY

(71) Applicant: Tesla, Inc., Austin, TX (US)

(72) Inventors: Chaitanya Gaikwad, Mountain View, CA (US); Zheqing Li, Cupertino, CA (US); Balaji Narayanasamy, Hayward, CA (US)

(21) Appl. No.: 19/170,963

(22) Filed: Apr. 4, 2025

(51) Int. Cl. H01F 27/30; H01F 27/02; H01F 27/24; H01F 41/06

(52) U.S. Cl. CPC H01F 27/306; H01F 27/02; H01F 27/24; H01F 41/06

(57) ABSTRACT

A magnetic assembly includes at least an electromagnetic core, a first winding, a second winding, and a magnetic shunt. The first winding and the second winding are attached to the electromagnetic core, and are separated by a space. The magnetic shunt is disposed in the space. The first winding and the second winding are configured to at least generate a magnetic field when an electric current passes the first winding and the second winding. The magnetic shunt is configured to at least control a magnetic flux associated with the magnetic field to improve electromagnetic performance.

### TECHNICAL FIELD

The present disclosure relates to electromagnetic components. More specifically, some embodiments of the present disclosure relate to toroidal magnetic assemblies integrated with magnetic shunt elements.

### BACKGROUND

Toroidal magnetics (e.g., magnetic core with doughnut-like or torus structure) are commonly used in inductors, transformers, and other electromagnetic components due to their efficient magnetic field containment and reduced electromagnetic interference (EMI). However, existing designs often face challenges in optimizing performance while maintaining compactness, particularly in high-performance applications where space is limited. There is a continuing demand for efficient electromagnetic compatibility (EMC) performance and/or improved noise filtering capabilities.

### SUMMARY

In some aspects, the techniques described herein relate to a toroidal magnetic assembly including: an electromagnetic core including a housing; a first winding at least partially wrapping around the electromagnetic core; a second winding at least partially wrapping around the electromagnetic core, the first winding and the second winding separated by a portion of the housing; and a first magnetic shunt disposed in the portion of the housing, wherein the first winding or the second winding is configured to at least generate a magnetic field when an electric current passes the first winding or the second winding, and wherein the first magnetic shunt is configured to at least modify a magnetic flux associated with the magnetic field.

In some aspects, the techniques described herein relate to a toroidal magnetic assembly, wherein a distance of the portion of the housing is between 4.0 mm to 7.0 mm.

In some aspects, the techniques described herein relate to a toroidal magnetic assembly, wherein a distance of the portion of the housing is determined based at least on a desired volume associated with the electromagnetic core and a desired differential mode inductance associated with the electromagnetic core.

In some aspects, the techniques described herein relate to a toroidal magnetic assembly, wherein the portion of the housing structurally forms a cavity, and wherein the first magnetic shunt is sized to fit in the cavity.

In some aspects, the techniques described herein relate to a toroidal magnetic assembly, wherein the first winding includes an orthogonal plate winding or a wire winding.

In some aspects, the techniques described herein relate to a toroidal magnetic assembly, wherein the first winding includes a U-shaped plate winding and an I-shaped plate winding that are joined in a butt weld arrangement.

In some aspects, the techniques described herein relate to a magnetic assembly including: an electromagnetic core including a housing; a first winding attached to the electromagnetic core; a second winding attached to the electromagnetic core, the first winding and the second winding separated by the housing; and a first magnetic shunt disposed in the housing, wherein the first winding or the second winding is configured to at least generate a magnetic field when an electric current passes the first winding or the second winding, and wherein the first magnetic shunt is configured to at least modify a magnetic flux associated with the magnetic field.

In some aspects, the techniques described herein relate to a magnetic assembly, wherein the first winding includes an orthogonal plate winding.

In some aspects, the techniques described herein relate to a magnetic assembly, wherein the electromagnetic core includes silicon steel, ferrite, or powdered iron.

In some aspects, the techniques described herein relate to a magnetic assembly, wherein the first winding includes copper, aluminum, or composite materials.

In some aspects, the techniques described herein relate to a magnetic assembly, wherein a distance associated with the housing is between 4.0 mm to 7.0 mm.

In some aspects, the techniques described herein relate to a magnetic assembly, wherein the housing structurally forms at least a cavity, and wherein the first magnetic shunt is sized to fit in the cavity.

In some aspects, the techniques described herein relate to a magnetic assembly, wherein the first magnetic shunt includes a magnetic shunt core and a shunt housing.

In some aspects, the techniques described herein relate to a magnetic assembly, wherein the first winding includes a U-shaped plate winding and an I-shaped plate winding that are joined in a butt weld arrangement.

In some aspects, the techniques described herein relate to a magnetic assembly, wherein the first magnetic shunt structurally forms an E-shape or an I-shape.

In some aspects, the techniques described herein relate to a process of assembling a magnetic assembly for power conversion, the process including: attaching first one or more windings to a first portion of a housing of an electromagnetic core; attaching second one or more windings to a second portion of the housing of the electromagnetic core; and disposing a first magnetic shunt to a third portion of the housing that separates the first one or more windings and the second one or more windings.

In some aspects, the techniques described herein relate to a process, wherein the third portion of the housing structurally forms at least a cavity, and wherein disposing the first magnetic shunt to the third portion of the housing includes disposing the first magnetic shunt into the cavity.

In some aspects, the techniques described herein relate to a process, wherein disposing the first magnetic shunt to the cavity includes gluing the first magnetic shunt to the third portion of the housing.

In some aspects, the techniques described herein relate to a process, wherein the first one or more windings include a first winding that includes a U-shaped plate winding and an I-shaped plate winding, and wherein attaching the first one or more windings to the first portion of the housing includes joining the U-shaped plate winding and the I-shaped plate winding in a butt weld arrangement.

In some aspects, the techniques described herein relate to a process, wherein a distance of the third portion of the housing that separates the first one or more windings and the second one or more windings is between 4.0 mm to 7.0 mm.

Additional details of example toroidal magnetics that can be used in conjunction with the present disclosure can be found in International Patent Application No. PCT/US2023/033938, the entirety of each of the disclosures is incorporated herein by reference.

### BRIEF DESCRIPTION OF THE DRAWINGS

Embodiments of the present disclosure are described with reference to the accompanying drawings, in which like reference characters reference like elements, and wherein:

FIG. 1 illustrates a perspective view of an example toroidal magnetic assembly according to some embodiments of the present disclosure.

FIG. 2 illustrates perspective views of individual components in the example toroidal magnetic assembly of FIG. 1 according to some embodiments of the present disclosure.

FIG. 3 illustrates an exploded view of an example toroidal magnetic assembly according to some embodiments of the present disclosure.

FIG. 4A and FIG. 4B are perspective view photographs of an example toroidal magnetic assembly, such as the example toroidal magnetic assembly of FIG. 1, according to some embodiments of the present disclosure.

FIG. 5 illustrates an enlarged view of a portion of the example toroidal magnetic assembly of FIG. 1 according to some embodiments of the present disclosure.

FIG. 6A illustrates an exploded view of an example toroidal magnetic assembly according to some embodiments of the present disclosure.

FIG. 6B illustrates a cross-sectional view representation of the example toroidal magnetic assembly of FIG. 6A.

FIG. 7A illustrates an exploded view of an example toroidal magnetic assembly according to some embodiments of the present disclosure.

FIG. 7B illustrates a cross-sectional view representation of the example toroidal magnetic assembly of FIG. 7A.

FIG. 8 is a flowchart of an example process for assembling a magnetic assembly according to some embodiments of the present disclosure.

### DETAILED DESCRIPTION

The following description of certain embodiments presents various descriptions of specific embodiments. However, the innovations described herein can be embodied in a multitude of different ways, for example, as defined and covered by the claims. In this description, reference is made to the drawings where like reference numerals can indicate identical or functionally similar elements. It will be understood that elements illustrated in the figures are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings. Any suitable principles and advantages of the embodiments disclosed herein can be implemented together with each other.

Generally described, one or more aspects of the present disclosure correspond to systems and methods that relate to magnetic assemblies with improved electromagnetic performance (e.g., enhanced differential mode inductance) while maintaining compactness (e.g., reducing and/or without increasing a volume of the toroidal magnetic assembly). More specifically, some embodiments of the present disclosure disclose integrating magnetic shunts into a toroidal magnetic assembly to enhance differential mode inductance while maintaining compactness of the toroidal magnetic assembly. In some embodiments, a multitude of windings (e.g., orthogonal plate windings and/or wire windings) are disposed around an electromagnetic core, with magnetic shunts strategically disposed in spaces between the multitude of windings. The toroidal magnetic assembly can be integrated into power converters, onboard chargers, and/or chokes used in electric vehicles or other electronic systems.

Advantageously, use of integrated magnetic shunts not only enhance electromagnetic performance (e.g., enhanced differential mode inductance, increased inductance value, and/or improved differential mode noise filtering) of the toroidal magnetic assembly, but reduce size of the toroidal magnetic assembly (e.g., reducing the need for standalone inductors, thereby saving space and reducing costs). Additionally and/or optionally, the toroidal magnetic assembly may be assembled based on a manufacturing process that involves stack welding, where a multitude of orthogonal plate windings are joined in a butt weld arrangement. Advantageously, stack welding allows the multitude of orthogonal plate windings to be joined in a compact and efficient manner (e.g., reducing overall size of the toroidal magnetic assembly).

In the field of power electronics and/or electromagnetic systems, toroidal magnetic assemblies (e.g., magnetic core with doughnut-like or torus structure) are commonly used due to their efficient magnetic field containment and reduced electromagnetic interference (EMI). For example, a toroidal magnetic assembly may be included in a choke that is used in electrical circuits to block or filter alternating current (AC) while allowing direct current (DC) to pass through, and/or filter out electromagnetic interference (EMI) and radio frequency interference (RFI) in power supplies and other electronic devices. The choke can be integrated in power converters and onboard chargers for electric vehicles.

Existing toroidal magnetic assemblies and/or chokes often rely on standalone inductors to achieve desired electromagnetic performance (e.g., differential mode inductance), which can lead to increased costs and larger footprints on printed circuit boards (PCBs). Solutions that have been previously developed typically involve the use of busbars and/or magnetic components to form inductors, with the busbars arranged in various configurations to optimize performance. However, these configurations may result in increased volume and heat losses, which can negatively impact the overall efficiency of power converters and/or onboard chargers. Additionally, the reliance on standalone inductors to achieve the desired inductance values may exacerbate the issue of space constraints on PCBs, making it difficult to achieve the desired compactness and efficiency in modern electronic systems.

To address at least a portion of the above problems, a toroidal magnetic assembly that integrates magnetic shunts to enhance electromagnetic performance (e.g., higher inductance value, lower electromagnetic losses, and/or higher differential mode inductance value) and/or reduce a volume of the toroidal magnetic assembly is disclosed in accordance with some embodiments of the present disclosure. In some embodiments, a toroidal magnetic assembly can include an electromagnetic core (e.g., a component made of steel, ferrite, powdered iron, and/or the like to concentrate or guide magnetic fields), a multitude of windings (e.g., orthogonal plate windings and/or wire windings made of materials such as copper), and magnetic shunts. The multitude of windings can at least partially wrap around the electromagnetic core to enhance magnetic coupling and/or reduce electromagnetic interference (e.g., by ensuring that the magnetic field lines are efficiently contained within the electromagnetic core). The magnetic shunts (e.g., components made of ferromagnetic materials) can be disposed between different windings (e.g., disposed in a gap or space between two sets of orthogonal plate windings).

The magnetic shunts can advantageously enhance electromagnetic performance (e.g., enhanced differential mode inductance, increased inductance value, and/or improved differential mode noise filtering) of the toroidal magnetic assembly and reduce size of the toroidal magnetic assembly (e.g., eliminating the need for standalone inductors, thereby saving space, enabling dense packaging, and/or reducing costs). In some embodiments, the toroidal magnetic assembly can be manufactured using techniques that involve stack welding, where plate windings are disposed in a butt weld arrangement (e.g., a U-shaped plate winding is placed on top and an I-shaped plate winding is placed at bottom) rather than in an edge joint arrangement (e.g., the U-shaped plate winding and the I-shaped plate winding are placed side-by-side). By utilizing stack welding, a volume of the toroidal magnetic assembly can be advantageously reduced by 60% to 70% (e.g., compared with the edge joint arrangement). Additionally, the toroidal magnetic assembly can exhibit higher inductance and lower electromagnetic losses under a unit volume, thereby increasing efficiency per volume and enhancing electromagnetic compatibility (EMC) functionality of the toroidal magnetic assembly.

As used herein, stack welding can refer to a technique or a method to join multiple components or layers. For example, in the context of the toroidal magnetic assembly, stack welding can refer to a method of joining two orthogonal plate windings in a butt weld arrangement. The butt weld arrangement can include a plate winding placed on top and the other plate winding placed at bottom, rather than placing two plate windings side-by-side. In the butt weld arrangement, edges of plate windings can be welded together (e.g., melting the edges of two plate windings to create a strong or seamless joint between the two plate windings) to form a cohesive structure. The butt weld arrangement can vertically stack plate windings, and enable a more compact design and packaging for the toroidal magnetic assembly.

In some embodiments, a gap (or can also be referred to herein as a length, or a distance of a space) between two sets of orthogonal plate windings that is used to accommodate a magnetic shunt can be of, of about, of at least, or of at least about 4.0 millimeter (mm), 4.5 mm, 5.0 mm, 5.5 mm, 6.0 mm, 6.5 mm, 7.0 mm, or any range of values therebetween. In other embodiments, the gap can be less than 4.0 mm, or greater than 7.0 mm. In some embodiments, the distance or the gap between two sets of orthogonal plate windings can be decided based on a combination of electromagnetic performance (e.g., desired inductance and magnetic flux path), physical constraints, material properties, thermal considerations, and/or manufacturing tolerances. For example, the gap or space can be determined to optimize, tradeoff, or balance electromagnetic performance and a volume of a toroidal magnetic assembly (e.g., differential mode inductance and the volume may go down as the gap decreases, and differential mode inductance may increase while the volume may increase as the gap increases). Advantageously, integrating a magnetic shunt into the space may enable a toroidal magnetic assembly to exhibit superior electromagnetic performance (e.g., increased differential mode inductance) while maintaining the space at a volume that allows cost-effective manufacturing.

In some embodiments, a toroidal magnetic assembly can be assembled or manufactured through a process that includes the following steps. First, an electromagnetic core can be obtained and housed in a housing. Second, a multitude of orthogonal plate windings can be welded (e.g., using stack welding to join a U-shaped winding and an I-shaped winding in a butt weld arrangement) to the housing associated with the electromagnetic core from a first side (e.g., a top side) of the electromagnetic core. Third, magnetic shunt cores can be disposed and fixated (e.g., using glue) into cavities formed by the housing associated with the electromagnetic core. The cavities can be on a second side (e.g., a bottom side) of the electromagnetic core.

Although the various aspects will be described in accordance with illustrative embodiments and combination of features, the examples and combination of features are illustrative in nature and should not be construed as limiting. More specifically, aspects of the present application may be applicable with various types of electric vehicles, power converters, onboard chargers, power electronic systems, and various components of vehicles under different contexts, such as when employed for automotives, vessels, or any kinds of vehicles. Still further, although specific architectures of toroidal magnetic assembly or electromagnetic infrastructure for use in components of electric vehicles, residential energy systems, or the like will be described, such illustrative toroidal magnetic assembly or electromagnetic infrastructure should not be construed as limiting. Accordingly, one skilled in the relevant art will appreciate that the aspects of the present application are not necessarily limited to any particular types of electric vehicles, power electronic systems, magnetic assemblies, or components of vehicles.

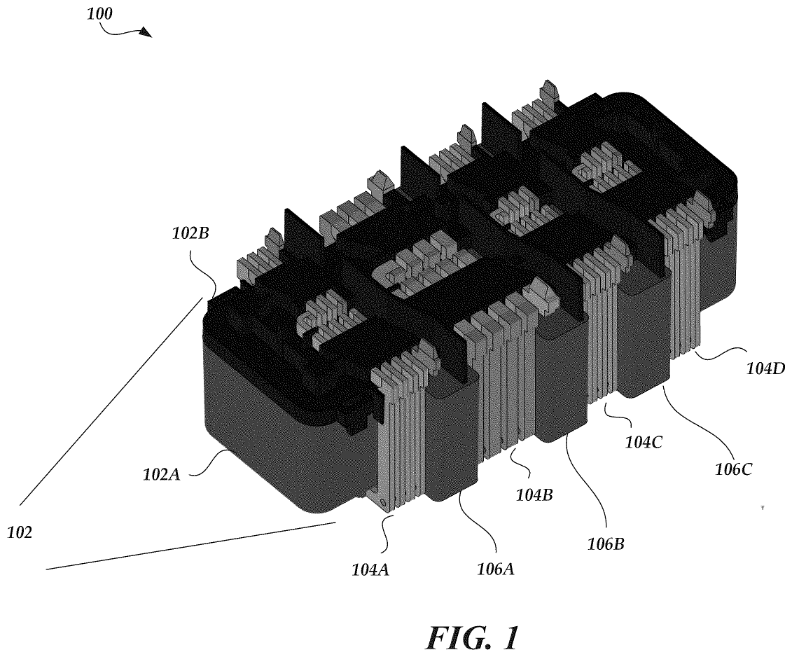

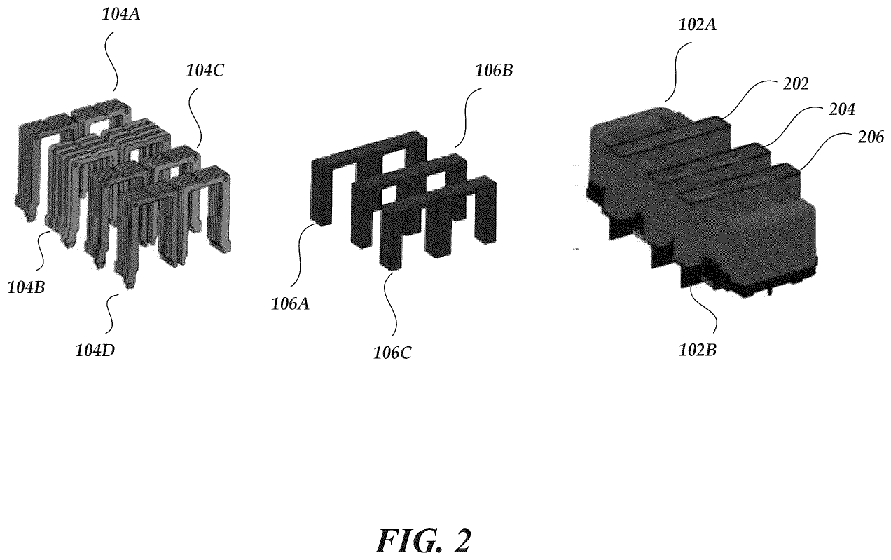

FIG. 1 illustrates a perspective view of an example toroidal magnetic assembly 100 according to some embodiments of the present disclosure. The toroidal magnetic assembly 100 can be at least used or integrated in power converters, onboard chargers, and/or other parts for electric vehicles to filter electromagnetic interference (EMI) noise or support other functionalities. As shown in FIG. 1, the toroidal magnetic assembly 100 can include an electromagnetic core 102, windings 104A, windings 104B, windings 104C, and windings 104D. The electromagnetic core 102 can include a housing 102A and a housing 102B. Although not readily observed in FIG. 1, the toroidal magnetic assembly 100 also includes a magnetic shunt 106A, a magnetic shunt 106B, a magnetic shunt 106C that are sized to fit in cavities (shown in FIG. 2) formed by the housing 102A.

In some examples, the electromagnetic core 102 is made of example materials such as silicon steel, ferrite, powdered iron, and/or other materials that can concentrate and guide magnetic fields. As shown in FIG. 1, the electromagnetic core includes the housing 102A and the housing 102B, which can provide mechanical support and protection. As noted above, the housing 102A can form cavities that are used to accommodate the magnetic shunt 106A, the magnetic shunt 106B, the magnetic shunt 106C.

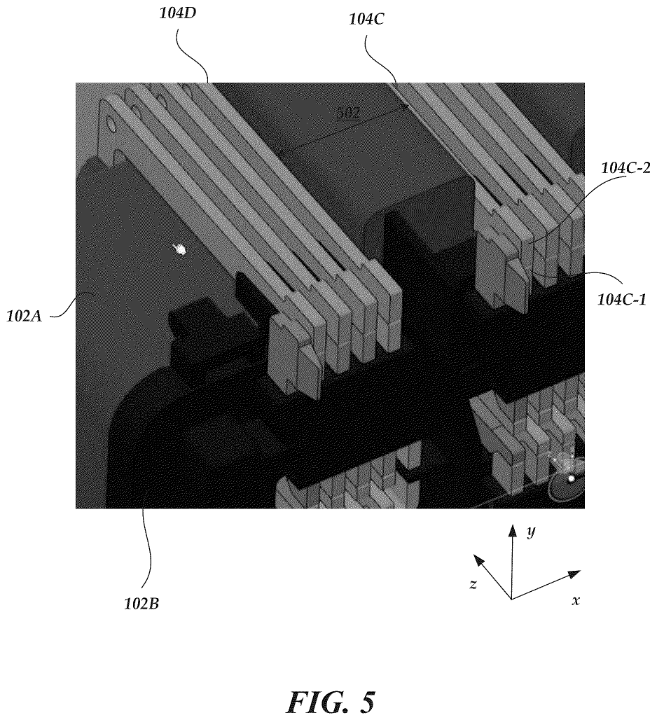

In some examples, the windings 104A, the windings 104B, the windings 104C, and the windings 104D can be made of materials such as copper, aluminum, composite materials, and/or other metals that can improve magnetic coupling or reduce electromagnetic interference. The windings 104A, 104B, 104C, and 104D are disposed around the electromagnetic core 102 to generate magnetic fields when an electric current passes through the windings 104A, 104B, 104C, and 104D. In some examples, each of the windings 104A, the windings 104B, the windings 104C, and/or the windings 104D can be or include orthogonal plate windings. Although FIG. 1 illustrates that each of the windings 104A, 104B, 104C, and 104D include at least four windings, it should be noted that number of windings in each of the windings 104A, 104B, 104C, and 104D can be more or less than four. As will be described with reference to FIG. 5, a winding in each of the windings 104A, 104B, 104C, and 104D can include a U-shaped winding and an I-shaped winding that are joined in a butt weld arrangement to advantageously reduce size of the toroidal magnetic assembly 100.

In some examples, the magnetic shunts 106A, 106B, and 106C are made of ferromagnetic materials to modify the magnetic flux associated with the magnetic fields generated by the windings 104A, 104B, 104C, and 104D and/or the electromagnetic core 102. As used herein, to modify the magnetic flux can refer to influence, alter, change, direct, or adjust the magnetic flux without requiring any external input or active intervention. For example, because of their presences and material properties, the magnetic shunts 106A, 106B, and 106C can influence, alter, change, or otherwise modify the path and distribution of magnetic field lines associated with the toroidal magnetic assembly 100. As noted above, although not readily observed in FIG. 1, the magnetic shunts 106A, 106B, and 106C are disposed or positioned in spaces between the windings 104A, 104B, 104C, and 104D. Advantageously, by integrating magnetic shunts 106A, 106B, and 106C into the toroidal magnetic assembly 100, the differential mode inductance can be increased, thereby leading to improved noise filtering capabilities and reduced electromagnetic losses. The inclusion of magnetic shunts 106A, 106B, and 106C can also eliminate the need for standalone inductors, resulting in cost savings and a more efficient use of space on printed circuit boards (PCBs) for integration of the toroidal magnetic assembly 100.

FIG. 2 illustrates perspective views of individual components in the example toroidal magnetic assembly 100 of FIG. 1 according to some embodiments of the present disclosure. As noted above, the toroidal magnetic assembly 100 includes at least the windings 104A, the windings 104B, the windings 104C, the windings 104D, the magnetic shunt 106A, the magnetic shunt 106B, the magnetic shunt 106C, the electromagnetic core 102 that includes the housing 102A and the housing 102B. Each of the windings 104A, the windings 104B, the windings 104C, and/or the windings 104D can be or include orthogonal plate windings

As shown in FIG. 2, the housing 102A of the electromagnetic core 102 can form a cavity 202, a cavity 204, and a cavity 206. In some examples, the magnetic shunt 106A can be sized to be disposed and fixated (e.g., using glue) in the cavity 202; the magnetic shunt 106B can be sized to be disposed and fixated in the cavity 204; the magnetic shunt 106C can be sized to be disposed and fixated in the cavity 206.

As noted above, by disposing the magnetic shunt 106A into a space (e.g., a space that includes the cavity 202 formed by the housing 102A) between the windings 104A and the windings 104B, electromagnetic performance (e.g., differential mode inductance, inductance value, and/or differential mode noise filtering) of the toroidal magnetic assembly 100 can be advantageously enhanced. Additionally, size and/or cost of the toroidal magnetic assembly 100 can be reduced (e.g., reducing the need for standalone inductors, thereby saving space and reducing costs).

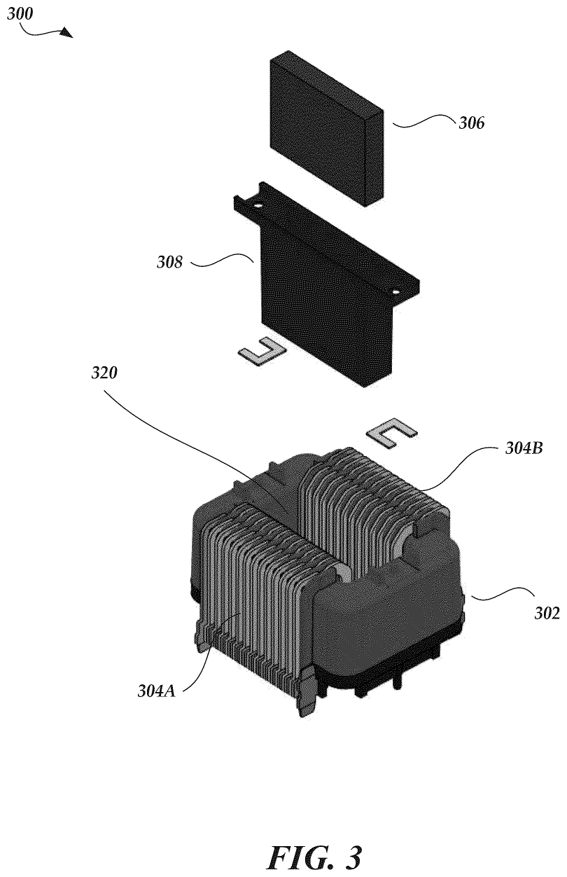

FIG. 3 illustrates an exploded view of an example toroidal magnetic assembly 300 according to some embodiments of the present disclosure. As shown in FIG. 3, the toroidal magnetic assembly 300 includes at least a magnetic shunt core 306, a magnetic shunt housing 308, an electromagnetic core 302, windings 304A, and windings 304B. The windings 304A and 304B are separated by a space 320.

In some examples, the electromagnetic core 302 is made of materials such as silicon steel, ferrite, powdered iron, and/or other materials that can concentrate and guide magnetic fields. The windings 304A and windings 304B can be made of materials such as copper, aluminum, composite materials, and/or other metals that can improve magnetic coupling or reduce electromagnetic interference. The windings 304A and 304B are disposed to at least partially wrap the electromagnetic core 302 for generating magnetic fields when an electric current passes through the windings 304A and 304B.

In some examples, the magnetic shunt core 306 is made of ferromagnetic materials to modify the magnetic flux associated with the magnetic fields generated by the windings 304A and 304B and/or the electromagnetic core 302. The magnetic shunt core 306 can modify the magnetic flux within the toroidal magnetic assembly 300, thereby enhancing the differential mode inductance and improving noise filtering capabilities.

In some examples, the magnetic shunt housing 308 can provide structural support and protection for the magnetic shunt core 306. The magnetic shunt housing 308 can ensure that the magnetic shunt core 306 is securely positioned within the toroidal magnetic assembly 300 to maintain the integrity and performance of the toroidal magnetic assembly 300. Although not illustrated in FIG. 3, the magnetic shunt core 306 and the magnetic shunt housing 308 can be disposed in the space 320 (e.g., a space structurally formed by the electromagnetic core 302) that separates the windings 304A and windings 304B.

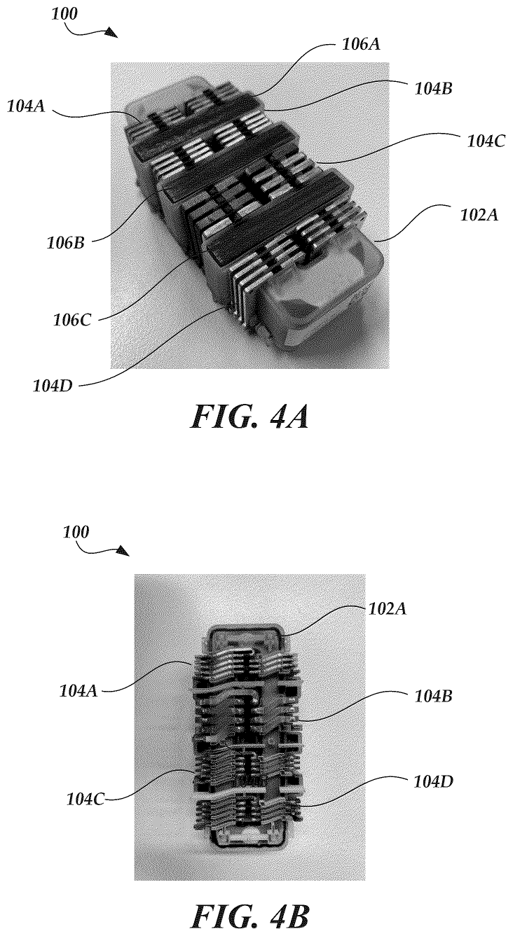

FIG. 4A and FIG. 4B are perspective view photographs of an example toroidal magnetic assembly, such as the example toroidal magnetic assembly 100 of FIG. 1, according to some embodiments of the present disclosure. FIG. 4A can illustrate a bottom view of the toroidal magnetic assembly 100, and FIG. 4B can illustrate a top view of the toroidal magnetic assembly 100.

As shown in FIG. 4A, the toroidal magnetic assembly 100 includes the windings 104A, 104B, 104C, and 104D that are disposed around the electromagnetic core 102 that includes the housing 102A. The magnetic shunts 106A, 106B, and 106C are disposed between the windings 104A, 104B, 104C, and 104D to at least modify the magnetic flux and enhance the differential mode inductance of the toroidal magnetic assembly 100. For example, because of their placements and material properties, the magnetic shunts 106A, 106B, and 106C can alter, redirect, contain, guide, or concentrate magnetic field lines, thereby enhancing the electromagnetic performance of the assembly (e.g., higher differential mode inductance and better noise suppression). As another example, the magnetic shunts 106A, 106B, and 106C can change the distribution of magnetic flux and provide preferred and/or concentrated paths for magnetic field lines, which can lead to increased inductance, improved noise filtering, and/or reduced electromagnetic interference. The housing 102A provides structural support and protection for the toroidal magnetic assembly 100.

FIG. 4B illustrates a top view of the toroidal magnetic assembly 100. As shown in FIG. 4B, the housing 102A of the electromagnetic core 102 can at least partially encapsulate windings (e.g., the windings 104A, 104B, 104C, and 104D) and magnetic shunts (the magnetic shunts 106A, 106B, and 106C). FIG. 4B illustrates compact design of the toroidal magnetic assembly 100, which allows for efficient use of space while maintaining or improving electromagnetic performance. The integration of magnetic shunts 106A, 106B, and 106C within the toroidal magnetic assembly 100 eliminates the need for standalone inductors, resulting in cost savings and a more efficient use of space on printed circuit boards (PCBs) for integrating the toroidal magnetic assembly 100.

Magnetic shunts (e.g., the magnetic shunts 106A, 106B, 106C, or the magnetic shunt core 306) integrated in a toroidal magnetic assembly (e.g., the toroidal magnetic assembly 100, the toroidal magnetic assembly 300) can be made of ferromagnetic materials (e.g., material with high magnetic permeability), and can modify the magnetic flux associated with the magnetic fields generated by windings (e.g., the windings 104A, 104B, 104C, 104D, 304A, 304B) and/or an electromagnetic core (e.g., the electromagnetic core 102, the electromagnetic core 302) associated with the toroidal magnetic assembly. In some examples, the magnetic shunts can be structured in in various shapes, such as E-shaped, I-shaped, or other shapes. As noted above, based on their placements and material properties, the magnetic shunts can modify the magnetic flux by altering, redirecting, containing, guiding, and/or concentrating magnetic field lines without requiring external input (e.g., do not require current to flow through) or active intervention. In some examples, the magnetic shunts are not required to be electrically coupled with the windings (e.g., not electrically coupled in series with the windings). Rather, based on their placements and material properties, the magnetic shunts can help mitigate differential mode noise that can occur when there is a difference in voltage between two conductors (e.g., two windings) carrying the same or similar current.

FIG. 5 illustrates an enlarged view of a portion of the example toroidal magnetic assembly 100 of FIG. 1 according to some embodiments of the present disclosure. The toroidal magnetic assembly 100 includes at least the housing 102A, the housing 102B, a winding 104C that includes a U-shaped winding 104C-2 and an I-shaped winding 104C-1. As shown in FIG. 5, the U-shaped winding 104C-2 and the I-shaped winding 104C-1 are joined together in a butt weld arrangement using stack welding techniques. More specifically, in the butt weld arrangement, the U-shaped winding 104C-2 can be placed on top and the I-shaped winding 104C-1 can be placed at bottom (e.g., along a “y” direction that is perpendicular to the “x” and “z” direction).

In some examples, a gap 502 or a distance of a space (e.g., a length in the “x” direction of the space that separates the winding 104C and the winding 104D) between the winding 104C and the winding 104D can be of, of about, of at least, or of at least about 4.0 millimeter (mm), 4.5 mm, 5.0 mm, 5.5 mm, 6.0 mm, 6.5 mm, 7.0 mm, or any range of values therebetween. In other embodiments, the gap 502 can be less than 4.0 mm, or greater than 7.0 mm. The space can include the cavity 206 shown in FIG. 2 that can accommodate a magnetic shunt (e.g., the magnetic shunt 106C).

Compared with other implementations (e.g., edge joint arrangement) where the U-shaped winding 104C-2 and the I-shaped winding 104C-1 are placed side-by-side (e.g., the U-shaped winding 104C-2 and the I-shaped winding 104C-1 are adjacent to or beside each other along the “x” direction), a volume of the toroidal magnetic assembly 100 can be advantageously reduced by 60% to 70%. Additionally, the toroidal magnetic assembly 100 can exhibit higher inductance and lower electromagnetic losses under a unit volume, thereby increasing efficiency per volume and enhancing electromagnetic compatibility (EMC) functionality of the toroidal magnetic assembly 100.

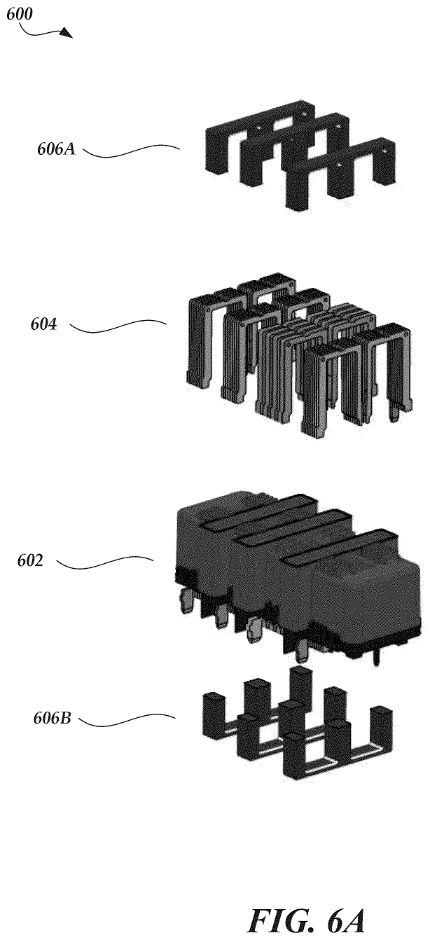

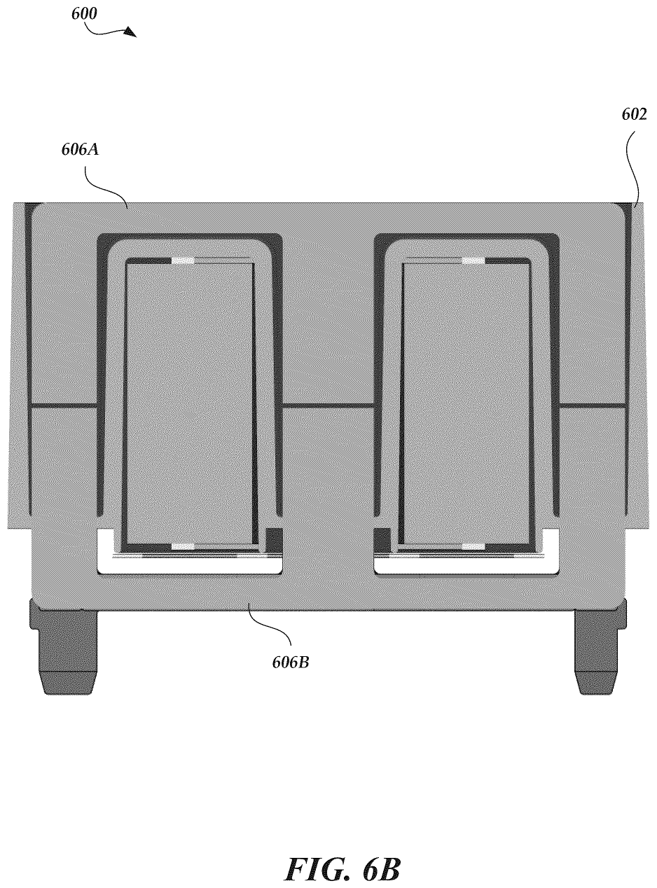

FIG. 6A illustrates an exploded view of an example toroidal magnetic assembly 600 according to some embodiments of the present disclosure. The toroidal magnetic assembly 600 can be structurally and/or functionally the same as or similar to the toroidal magnetic assembly 100. As shown in FIG. 6A, the toroidal magnetic assembly 600 can include at least an electromagnetic core 602, magnetic shunts 606A, magnetic shunts 606B, and windings 604. Unless otherwise noted, the components of FIG. 6A can be the same as or generally similar to like-numbered components of FIG. 1.

As shown in FIG. 6A, the magnetic shunts 606A and the magnetic shunts 606B can be structurally configured to form an E-shaped structure. Each of the magnetic shunts 606A and/or the magnetic shunts 606B can form an individual E-shaped structure. The magnetic shunts 606A and the magnetic shunts 606B can be oriented differently for integration with the electromagnetic core 602 from opposite sides (e.g., a top side and a bottom side) of the electromagnetic core 602. The E-shaped configuration associated with the magnetic shunts 606A and the magnetic shunts 606B can provide structural support, enhance electromagnetic performance, and/or effective assembly of the toroidal magnetic assembly 600.

FIG. 6B illustrates a cross-sectional view representation of the example toroidal magnetic assembly 600 of FIG. 6A. As shown in FIG. 6B, the magnetic shunts 606A can be integrated with the electromagnetic core 602 from a first side (e.g., a top side) of the electromagnetic core 602. The magnetic shunts 606B can be integrated with the electromagnetic core 602 from a second side (e.g., a bottom side) of the electromagnetic core 602.

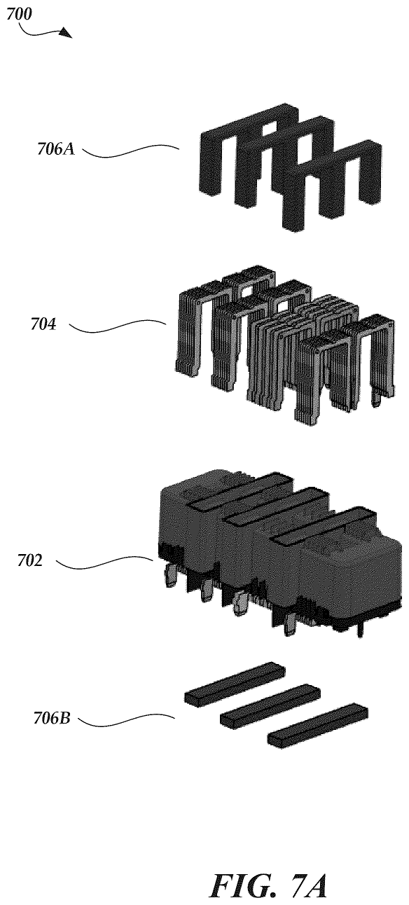

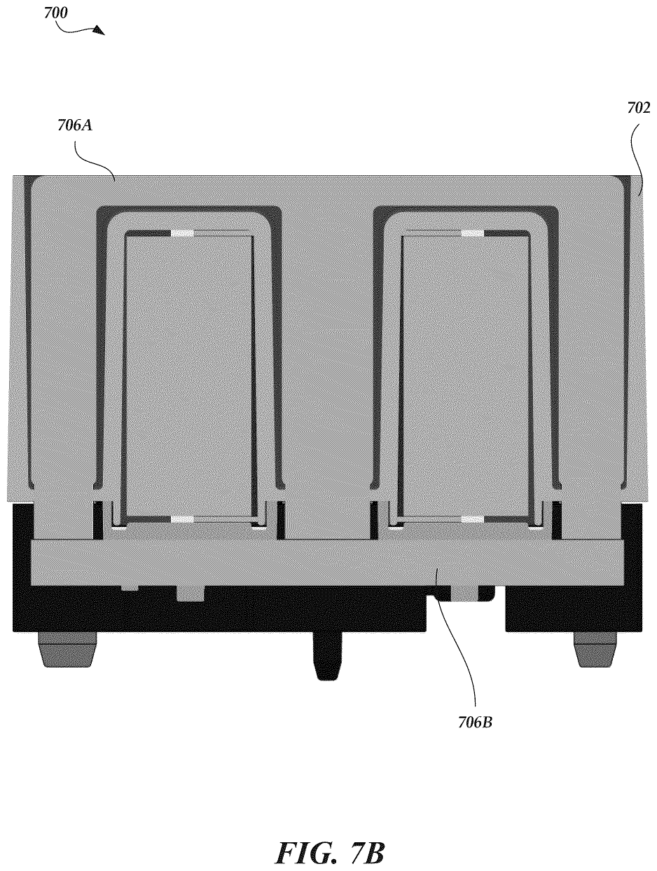

FIG. 7A illustrates an exploded view of an example toroidal magnetic assembly 700 according to some embodiments of the present disclosure. The toroidal magnetic assembly 700 can be structurally and/or functionally the same as or similar to the toroidal magnetic assembly 100. As shown in FIG. 7A, the toroidal magnetic assembly 700 can include at least an electromagnetic core 702, magnetic shunts 706A, magnetic shunts 706B, and windings 704. Unless otherwise noted, the components of FIG. 7A can be the same as or generally similar to like-numbered components of FIG. 1.

As shown in FIG. 7A, the magnetic shunts 706A can be structurally configured to form an E-shaped structure. The magnetic shunts 706B can be structurally configured to form an I-shaped structure.

FIG. 7B illustrates a cross-sectional view representation of the example toroidal magnetic assembly 700 of FIG. 7A. As shown in FIG. 7B, the magnetic shunts 706A can be integrated with the electromagnetic core 702 from a first side (e.g., a top side) of the electromagnetic core 702. The magnetic shunts 706B can be integrated with the electromagnetic core 702 from a second side (e.g., a bottom side) of the electromagnetic core 702.

It will be understood that various combinations or configurations for integrating magnetic shunts with an electromagnetic core are within the scope of the present disclosure. In some examples, E-shaped and/or I-shaped magnetic shunts can be integrated on a top side of an electromagnetic core. In some examples, E-shaped and/or I-shaped magnetic shunts can be integrated on a bottom side of an electromagnetic core. In some examples, E-shaped and/or I-shaped magnetic shunts can be integrated on both a top side and a bottom side of an electromagnetic core. In some examples, magnetic shunts integrated with an electromagnetic core can be structurally configured to form other shapes (e.g., a U-shape).

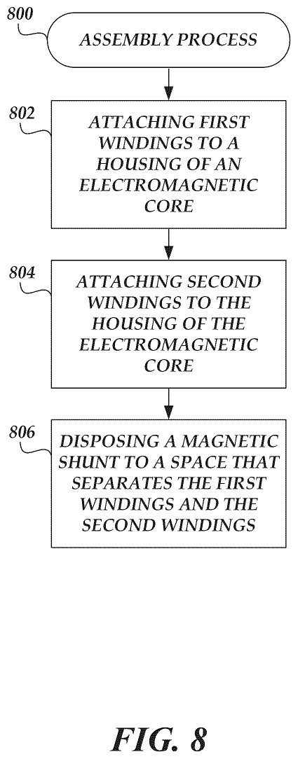

FIG. 8 is a flowchart of an example assembly process 800 (or simply referred to herein as a process) for assembling a magnetic assembly according to some embodiments of the present disclosure. In some examples, the process 800 can be used to assemble the toroidal magnetic assembly 100 of FIG. 1, the toroidal magnetic assembly 600 of FIG. 6B, and the toroidal magnetic assembly 700 of FIG. 7B.

The process 800 begins at block 802. At block 802, first one or more windings can be attached to a housing of an electromagnetic core. For example, first one or more windings (e.g., the windings 104C of FIG. 2) can be attached to the housing 102A of the electromagnetic core 102. The housing 102A can be attached to the housing 102B before the first one or more windings are attached.

In some examples, a winding 104C of FIG. 5 can be attached to the housing 102A and/or the housing 102B using stack welding techniques. In some examples, the windings 604 can be attached to the electromagnetic core 602 using stack welding techniques. In some examples, the windings 704 can be attached to the electromagnetic core 702 using stack welding techniques. For example, as noted above, the winding 104C can include a U-shaped winding 104C-2 and an I-shaped winding 104C-1. The U-shaped winding 104C-2 and the I-shaped winding 104C-1 can be joined together in a butt weld arrangement using stack welding techniques. In the butt weld arrangement, the U-shaped winding 104C-2 can be placed on top and the I-shaped winding 104C-1 can be placed at bottom (e.g., along a “y” direction that is perpendicular to the “x” and “z” direction as shown in FIG. 5).

At block 804, second one or more windings can be attached to a housing of an electromagnetic core. For example, second one or more windings (e.g., the windings 104D) can be attached to the housing 102A of the electromagnetic core 102. In some examples, similar to attaching the winding 104C of FIG. 5 to the housing 102A and/or the housing 102B, a winding 104D of FIG. 5 can be attached to the housing 102A and/or the housing 102B using stack welding techniques such that a U-shaped winding of the winding 104D and an I-shaped winding of the winding 104D can be joined together in a butt weld arrangement.

At block 806, a magnetic shunt can be disposed to a space that separates the first one or more windings and the second one or more windings. For example, the magnetic shunt 106C of FIG. 4A can be disposed to a space (e.g., the space including the gap 502 of FIG. 5) that separates the windings 104C and the windings 104D. The space can be structurally formed by the housing 102A of the electromagnetic core 102. More specifically, the magnetic shunt 106C can be disposed in (e.g., using glue for gluing the magnetic shunt 106C to the housing 102A) the cavity 206 (shown in FIG. 2) formed by the housing 102A.

It should be noted that descriptions above with reference to FIG. 8 focus on examples of using U-shaped and I-shaped windings that are illustrated in FIG. 2 and/or FIG. 5 (e.g., the U-shaped winding 104C-2 and the I-shaped winding 104C-1) in the process 800. It will be understood that other shapes of windings (such as those illustrated in FIGS. 6A and 7A) can be used in an assembly process (e.g., the process 800) and fall within the scope of the disclosure.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosed display assemblies.

It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural. Further, various embodiments disclosed herein are to be taken in the illustrative and explanatory sense, and should in no way be construed as limiting of the present disclosure.

All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other. Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

The illustrative algorithms described in connection with the embodiments disclosed herein can be implemented as electronic hardware (e.g., ASICs or FPGA devices), computer software that runs on computer hardware, or combinations of both. Moreover, the various illustrative logical blocks and modules described in connection with the embodiments disclosed herein can be implemented or performed by a machine, such as a processor device, a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the rendering techniques described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

It will also be appreciated that one or more of the elements depicted in the drawings/figures can also be implemented in a more separated or integrated manner, or even removed or rendered as inoperable in certain cases, as is useful in accordance with a particular application.

What is claimed is:

1. A toroidal magnetic assembly comprising:
an electromagnetic core comprising a housing;
a first winding at least partially wrapping around the electromagnetic core;
a second winding at least partially wrapping around the electromagnetic core, the first winding and the second winding separated by a portion of the housing; and
a first magnetic shunt disposed in the portion of the housing,
wherein the first winding or the second winding is configured to at least generate a magnetic field when an electric current passes the first winding or the second winding, and wherein the first magnetic shunt is configured to at least modify a magnetic flux associated with the magnetic field.

2. The toroidal magnetic assembly of claim 1, wherein a distance of the portion of the housing is between 4.0 mm to 7.0 mm.

3. The toroidal magnetic assembly of claim 1, wherein a distance of the portion of the housing is determined based at least on a desired volume associated with the electromagnetic core and a desired differential mode inductance associated with the electromagnetic core.

4. The toroidal magnetic assembly of claim 1, wherein the portion of the housing structurally forms a cavity, and wherein the first magnetic shunt is sized to fit in the cavity.

5. The toroidal magnetic assembly of claim 1, wherein the first winding comprises an orthogonal plate winding or a wire winding.

6. The toroidal magnetic assembly of claim 1, wherein the first winding comprises a U-shaped plate winding and an I-shaped plate winding that are joined in a butt weld arrangement.

7. A magnetic assembly comprising:
an electromagnetic core comprising a housing;
a first winding attached to the electromagnetic core;
a second winding attached to the electromagnetic core, the first winding and the second winding separated by the housing; and
a first magnetic shunt disposed in the housing,
wherein the first winding or the second winding is configured to at least generate a magnetic field when an electric current passes the first winding or the second winding, and wherein the first magnetic shunt is configured to at least modify a magnetic flux associated with the magnetic field.

8. The magnetic assembly of claim 7, wherein the first winding comprises an orthogonal plate winding.

9. The magnetic assembly of claim 7, wherein the electromagnetic core comprises silicon steel, ferrite, or powdered iron.

10. The magnetic assembly of claim 7, wherein the first winding comprises copper, aluminum, or composite materials.

11. The magnetic assembly of claim 7, wherein a distance associated with the housing is between 4.0 mm to 7.0 mm.

12. The magnetic assembly of claim 7, wherein the housing structurally forms at least a cavity, and wherein the first magnetic shunt is sized to fit in the cavity.

13. The magnetic assembly of claim 7, wherein the first magnetic shunt comprises a magnetic shunt core and a shunt housing.

14. The magnetic assembly of claim 7, wherein the first winding comprises a U-shaped plate winding and an I-shaped plate winding that are joined in a butt weld arrangement.

15. The magnetic assembly of claim 7, wherein the first magnetic shunt structurally forms an E-shape or an I-shape.

16. A process of assembling a magnetic assembly for power conversion, the process comprising:
attaching first one or more windings to a first portion of a housing of an electromagnetic core;
attaching second one or more windings to a second portion of the housing of the electromagnetic core; and
disposing a first magnetic shunt to a third portion of the housing that separates the first one or more windings and the second one or more windings.

17. The process of claim 16, wherein the third portion of the housing structurally forms at least a cavity, and wherein disposing the first magnetic shunt to the third portion of the housing comprises disposing the first magnetic shunt into the cavity.

18. The process of claim 17, wherein disposing the first magnetic shunt to the cavity comprises gluing the first magnetic shunt to the third portion of the housing.

19. The process of claim 16, wherein the first one or more windings comprise a first winding that includes a U-shaped plate winding and an I-shaped plate winding, and wherein attaching the first one or more windings to the first portion of the housing comprises joining the U-shaped plate winding and the I-shaped plate winding in a butt weld arrangement.

20. The process of claim 16, wherein a distance of the third portion of the housing that separates the first one or more windings and the second one or more windings is between 4.0 mm to 7.0 mm.
